(19) United States
(12) Patent Application Publication
(10) Pub. No.: US 2006/0159877 A1
(43) Pub. Date: Jul. 20, 2006

(54) Composite container and non-foil high-barrier liner therefor

(75) Inventor: Srinivas Nomula, Hartsville, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sonoco Development, Inc.

(21) Appl. No.: 11/039,686

(22) Filed: Jan. 19, 2005

(51) Int. Cl. B32B 27/10

(52) U.S. Cl. 428/34.2

(57) ABSTRACT

A non-foil-based liner for composite containers has a two-ply construction, comprising a paper outer ply adapted to be adhered to an inner surface of a body wall of a composite container, and an inner ply laminated to the paper outer ply by an intervening tie layer. The inner ply comprises a polymer film core layer having an outer surface and an inner surface, a vapor-deposited metal layer joined to the outer surface of the film core layer, and a sealant layer disposed on the inner surface of the film core layer. The tie layer can comprise a polyester urethane adhesive, or can be a coextruded layer having an outer sublayer contiguous with the outer ply and an inner sublayer contiguous with the inner ply. The outer sublayer advantageously comprises polyethylene such as low-density polyethylene. The inner sublayer advantageously comprises an acrylic acid-based polymer such as ethylene methacrylic acid.

### BACKGROUND OF THE INVENTION

The present invention relates to polymer film laminates, and more particularly relates to such laminates useful in applications such as composite containers.

Composite containers comprise wound paperboard container bodies lined by an impervious liner that provides a barrier against the passage of oxygen and/or moisture. In some applications, the liner must provide a high degree of barrier performance, which is achievable with metal foil-based liners. Typical foil-based liners are laminated structures such as {paper/foil/sealant}, or {sealant/foil/sealant}. Because it is a relatively costly component of the liner, it would be desirable to eliminate the metal foil layer, while still achieving high levels of barrier performance.

### BRIEF SUMMARY OF THE INVENTION

The present invention addresses the above needs and achieves other advantages, by providing a non-foil-based liner for composite containers. The liner has a two-ply construction, comprising a paper outer ply adapted to be adhered to an inner surface of a body wall of a composite container, and an inner ply laminated to the paper outer ply by an intervening tie layer. The inner ply comprises a polymer film core layer having an outer surface and an inner surface, a vapor-deposited metal layer joined to the outer surface of the film core layer, and a sealant layer disposed on the inner surface of the film core layer. The sealant layer forms the innermost surface of the container and is operable for sealing opposite edges of the liner to each other at a fold seal therebetween.

The inner and outer plies can be laminated either by adhesive lamination or extrusion lamination. In the case of adhesive lamination, the tie layer in one embodiment comprises a urethane-based adhesive. Advantageously, the urethane-based adhesive comprises a polyester urethane adhesive.

In the case of extrusion lamination, the tie layer comprises a coextruded layer having an outer sublayer contiguous with the outer ply and an inner sublayer contiguous with the inner ply, the outer and inner sublayers comprising different polymer materials. The outer sublayer advantageously comprises polyethylene such as low-density polyethylene. The inner sublayer advantageously comprises an acrylic acid-based polymer such as ethylene methacrylic acid.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an exploded perspective view of a container in accordance with one embodiment of the invention;

FIG. 2 is a cross-sectional view through the container body, along line 2-2 in FIG. 1;

FIG. 3 is a cross-sectional view, on an enlarged scale, showing a liner in accordance with one embodiment of the invention;

FIG. 4 is a view similar to FIG. 3, showing another embodiment of the invention; and

FIG. 5 is a cross-sectional view of yet another embodiment of the invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

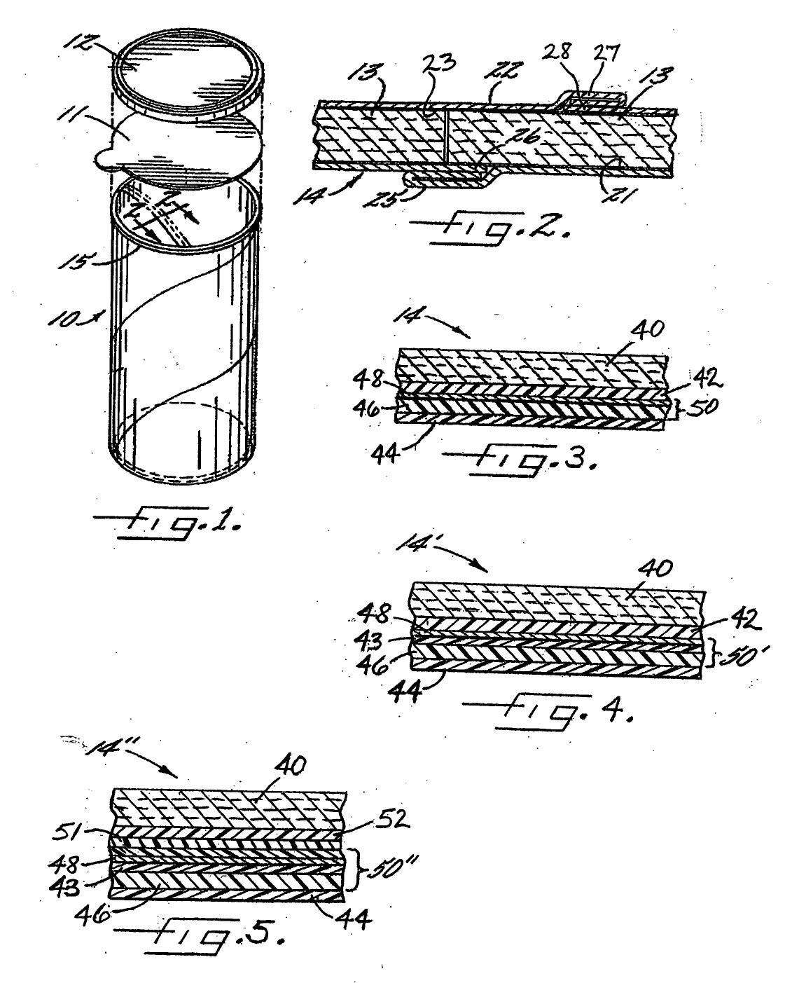

With reference to FIGS. 1 and 2, there is shown a composite container 10 having a non-foil-based label in accordance with one embodiment of the present invention. Although illustrated as having a circular cross-section, the tubular container 10 may have any cross-sectional shape that can be formed by wrapping the composite materials around an appropriately shaped mandrel. For example, the tube can be formed in a rectangular shape with rounded corners by convolutely wrapping the materials around a suitably shaped mandrel. The embodiment illustrated in FIG. 1 is particularly advantageous for packaging potato crisps or chips and includes a flexible membrane lid 11 and a reusable plastic end cap 12 over the membrane lid. Various other end closures may be used, however, depending upon the type of product that is to be packaged. For example, where dough is to be packaged, the end caps are typically constructed of metal and are crimp-sealed onto the ends of the container.

The tubular container 10 includes a wall having one or more body plies 13 (FIG. 2) preferably formed of paperboard and a liner ply 14 adhered to the inner surface of the body ply or plies 13. The upper end of the tubular container 10 is rolled over so as to form a bead 15 or flange and the membrane lid 11 is hermetically sealed to the top of the bead. The end cap 12 is then snapped over the bead 15 and may be reused after the membrane lid 11 has been removed. A metal closure (not illustrated) can be secured to the opposite end of the container 10. Alternative closure systems can be used at the container ends. For instance, the top closure can employ a metal ring in conjunction with a membrane lid sealed to the ring.

The seams where the various plies are joined together are illustrated in FIG. 2. In some types of containers such as self-opening containers (e.g., for refrigerated dough), a single body ply is used and the edges of the ply are first skived and then joined together during the tube-forming process with an adhesive to create a strong seam. In other types of containers, a single or multiple body plies may be used and the edges of the ply or plies are not skived and form a butt joint as shown in FIG. 2, or form an overlap joint. In any event, the liner ply 14 is adhered to the inner surface of the body ply or plies 13 with a wet adhesive 21 and the overlapping edges of the liner ply are sealed together to ensure that the container 10 is completely sealed. A label ply 22 is adhered to the outer surface of the body ply 13 with an adhesive 23, and can have various graphics and/or indicia printed thereon regarding the product within the container. The liner ply 14 includes a fold seal formed by overlapping a folded first edge portion 25 of the liner with an opposite second edge portion 26 of the liner and sealing the overlapping edge portions together. Likewise, the label 22 includes a fold seal formed by overlapping a folded first edge portion 27 with an opposite second edge portion 28 of the label and sealing the edge portions together. Alternatively, the label can be seamed with a simple lap seal in which the first edge portion 27 is not folded.

A liner structure in accordance with a first embodiment of the invention is schematically depicted in FIG. 3. The liner 14 is free of any metal foil layers. The liner includes a backing layer 40 of paper such as inextensible kraft or the like. The paper layer 40 is adhesive-laminated to a metallized film 50; thus, layer 42 represents a tie layer of adhesive. The liner also includes a sealant layer 44 disposed on the opposite surface of the metallized film 50 from the paper layer 40. The sealant layer 44 comprises a heat seal material. Various heat seal materials may be used, including but not limited to ionomer resins (e.g., SURLYN®, an ethylene acid copolymer with acid groups partially neutralized with zinc or sodium ions), high-density polyethylene (HDPE), low-density polyethylene (LDPE), coextruded film structures (e.g., ionomer/HDPE coex, LDPE/HDPE coex, etc.). The particular sealant material is not of importance to the present invention.

The metallized film 50 comprises the primary barrier layer of the liner. The metallized film in this embodiment comprises a film core layer 46 and a metal layer 48. The metal layer 48 is vacuum- or vapor-deposited on the surface of the film core layer 46, which serves as the substrate for the metal layer. Various metals can be used, but aluminum is most commonly employed. Processes for metallizing film are well known and are not further described herein. The film core layer 46 can comprise various polymers, including but not limited to polyethylene, polypropylene, polyester such as polyethylene terephthalate, nylon, and the like.

The adhesive tie layer 42 comprises a urethane-based adhesive, and advantageously comprises a polyester urethane adhesive. It has been found that the barrier performance of the liner is improved when a polyester urethane adhesive is used, in comparison with other types of laminating adhesives. A suitable polyester urethane adhesive useful in the practice of the invention is Adcote® 522A/522B two-component polyester urethane adhesive available from Rohm & Haas. The 522A component is an isocyanate-terminated polyester urethane and the 522B component is a coreactant.

The liner structure of FIG. 3 can achieve reasonably good barrier performance, but may not be sufficient for some types of products requiring extremely high-barrier performance. FIG. 4 shows an alternative liner structure that offers enhanced barrier potential. The liner 14′ is generally similar to that of FIG. 3, including a paper layer 40 adhesive-laminated by an adhesive tie layer 42 to a metallized film 50′ and having a sealant layer 44. However, the metallized film 50′ includes a coating 43 on the film core layer 46 for promoting the uniform and continuous metallization of the film core layer. The metallization-promoting coating 43 can comprise an acrylate, polyvinyl alcohol, ethylene vinyl alcohol, polyester copolymer (e.g., PET copolymer), or the like. Alternatively, the surface of the film core layer can be plasma-treated prior to metallization to enhance the uniformity and continuity of the metal layer 48. The coating 43 or plasma treatment thus enhance the barrier performance of the metallized film, since discontinuities in the metal layer have deleterious effects on barrier performance.

With respect to discontinuities in the metal layer 48, although some of them can result from the metallization process itself, in other cases they can be introduced subsequent to metallization such as by inadvertently scratching the metal layer during handling of the film. To reduce the incidence of such breaches in the metal layer, it is advantageous for the metallized film to include a protective coating over the metal layer. FIG. 5 shows a liner 14″ having such a metallized film. The liner 14″ includes a metallized film 50″ and a sealant layer 44. The metallized film 50″ includes a coating 43 on the film core layer 46 for promoting the uniform and continuous metallization of the film core layer, and also includes a protective coating 49 applied over the metal layer 48 of the metallized film. The protective coating can comprise various materials including but not limited to a lacquer (e.g., nitrocellulose, acrylic, etc.) or a vacuum acrylate coating.

The liner 14″ also differs from the prior embodiments in that the paper layer 40 is extrusion-laminated to the metallized film 50″ via a coextruded layer having an inner sub-layer 51 and an outer sub-layer 52 that are different polymers. The inner sub-layer 51 advantageously comprises an acrylic acid-based polymer such as ethylene methacrylic acid. The outer sub-layer advantageously comprises a polyethylene such as low-density polyethylene. It has been found that extrusion laminating the liner using a coextruded LDPE/EMAA layer results in a liner having better barrier performance than when LDPE alone is used for extrusion laminating the liner.

The liners in accordance with the invention advantageously are two-ply structures formed by laminating two separate webs together. For instance, one web can comprise the metallized film 50, 50′, 50″ having the sealant layer 44, and the other web can comprise the paper layer 40. As such, the liners can be prepared in a single-pass laminating operation, which offers distinct advantages over multi-pass operations often required for high-barrier laminate construction. Thus, in the case of adhesive lamination, the paper web and the web having the metallized film and sealant layer are advanced toward a laminating nip and a laminating adhesive is applied to one of the webs and the webs are laminated together in the nip and the resulting laminate is wound into a roll. In the case of extrusion lamination, the two webs are advanced toward the nip and a coextruded layer is extruded between the webs as they approach the nip, and the webs are laminated together in the nip and the resulting laminate is wound into a roll.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A composite container, comprising:
a tubular body wall comprising at least one paperboard body ply wrapped into a tubular shape, the body wall having an inner surface of paperboard; and
a two-ply liner adhered to the inner surface of the body wall, the liner comprising a paper outer ply having one side adhered to the inner surface of the body wall, and an inner ply laminated to the paper outer ply by an intervening tie layer, the inner ply comprising a polymer film core layer having an outer surface and an inner surface, a vapor-deposited metal layer joined to the outer surface of the film core layer, and a sealant layer disposed on the inner surface of the film core layer, the sealant layer forming the innermost surface of the container and sealing opposite edges of the liner to each other at a fold seal therebetween;
wherein the tie layer comprises one of (1) an adhesive layer comprising a urethane-based adhesive, and (2) a coextruded layer having an outer sublayer contiguous with the outer ply and an inner sublayer contiguous with the inner ply, the outer and inner sublayers comprising different polymer materials.

2. The composite container of claim 1, wherein the tie layer comprises the coextruded layer and the outer sublayer comprises low-density polyethylene.

3. The composite container of claim 1, wherein the tie layer comprises the coextruded layer and the inner sublayer comprises ethylene methacrylic acid.

4. The composite container of claim 1, wherein the tie layer comprises the coextruded layer and the outer sublayer comprises low-density polyethylene and the inner sublayer comprises ethylene methacrylic acid.

5. The composite container of claim 1, wherein the tie layer comprises the adhesive layer and the adhesive comprises polyester urethane adhesive.

6. The composite container of claim 1, wherein the outer surface of the film core layer is treated to improve uniformity of coverage of the vapor-deposited metal layer.

7. The composite container of claim 1, wherein the outer surface of the film core layer is coated with a metallization-promoting material before vapor-deposition of the metal layer.

8. The composite container of claim 7, wherein the metallization-promoting material is selected from the group consisting of acrylate, polyvinyl alcohol, ethylene vinyl alcohol, and polyester copolymer.

9. The composite container of claim 1, wherein the vapor-deposited metal layer is covered by a protective layer.

10. The composite container of claim 9, wherein the protective layer is selected from the group consisting of vacuum acrylate, nitrocellulose lacquer, and acrylic lacquer.

11. The composite container of claim 1, wherein the outer surface of the film core layer is coated with a metallization-promoting material before vapor-deposition of the metal layer, and the vapor-deposited metal layer is covered by a protective layer.

12. A two-ply liner for a composite container, the liner comprising:
a paper outer ply adapted to be adhered to an inner surface of a body wall of a composite container, and an inner ply laminated to the paper outer ply by an intervening tie layer, the inner ply comprising a polymer film core layer having an outer surface and an inner surface, a vapor-deposited metal layer joined to the outer surface of the film core layer, and a sealant layer disposed on the inner surface of the film core layer, the sealant layer forming the innermost surface of the liner and being operable for sealing opposite edges of the liner to each other at a fold seal therebetween;
wherein the tie layer comprises one of (1) an adhesive layer comprising a urethane-based adhesive, and (2) a coextruded layer having an outer sublayer contiguous with the outer ply and an inner sublayer contiguous with the inner ply, the outer and inner sublayers comprising different polymer materials.

13. The two-ply liner of claim 12, wherein the tie layer comprises the adhesive layer and the adhesive comprises a polyester urethane adhesive.

14. The two-ply liner of claim 12, wherein the tie layer comprises the coextruded layer and the outer sublayer comprises low-density polyethylene.

15. The two-ply liner of claim 12, wherein the tie layer comprises the coextruded layer and the inner sublayer comprises ethylene methacrylic acid.

16. The two-ply liner of claim 12, wherein the tie layer comprises the coextruded layer and the outer sublayer comprises low-density polyethylene and the inner sublayer comprises ethylene methacrylic acid.
